(19) United States
(12) Patent Application Publication
(10) Pub. No.: US 2006/0067650 A1
(43) Pub. Date: Mar. 30, 2006

(54) Method of making a reflective display device using thin film transistor production techniques

(76) Inventor: Clarence Chui, San Mateo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/208,072

(22) Filed: Aug. 19, 2005

Related U.S. Application Data
(60) Provisional application No. 60/613,452, filed on Sep. 27, 2004.

(51) Int. Cl. G02B 6/00

(52) U.S. Cl. 385/147

(57) ABSTRACT

MEMS devices (such as interferometric modulators) may be fabricated using thin film transistor (TFT) manufacturing techniques. In an embodiment, a MEMS manufacturing process includes identifying a TFT production line and arranging for the manufacture of MEMS devices on the TFT production line. In another embodiment, an interferometric modulator is at least partially fabricated on a production line previously configured for TFT production.

### CROSS-REFERENCE TO RELATED APPLICATIONS

This application claims priority to U.S. Provisional Application No. 60/613,452, filed Sep. 27, 2004, which is hereby incorporated by reference in its entirety.

### BACKGROUND

1. Field of the Invention

This invention relates to microelectromechanical systems for use as interferometric modulators. More particularly, this invention relates to systems and methods for improving the micro-electromechanical operation of interferometric modulators.

2. Description of the Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

An embodiment provides a MEMS manufacturing process that includes identifying a thin film transistor production line at a first manufacturing plant; and arranging for the first manufacturing plant to manufacture a partially fabricated interferometric modulator on the thin film transistor production line. Another embodiment provides a partially fabricated interferometric modulator made by such a MEMS manufacturing process.

Another embodiment provides a method of making an interferometric modulator that includes at least partially fabricating a thin film transistor on a production line; reconfiguring the production line to form a reconfigured production line; and at least partially fabricating an interferometric modulator on the reconfigured production line. Another embodiment provides a partially fabricated interferometric modulator made by such a method.

Another embodiment provides a method of making an interferometric modulator that includes receiving a partially fabricated interferometric modulator at a second production line, the partially fabricated interferometric modulator having been made on a first production line configured for at least partially fabricating a non-interferometric device; and subjecting the partially fabricated interferometric modulator to at least one manufacturing step on the second production line. Another embodiment provides an interferometric modulator made by such a method.

Another embodiment provides a method for making an interferometric modulator that includes fabricating a partially fabricated interferometric modulator on a reconfigured production line, the reconfigured production line having been previously configured for at least partially fabricating a thin film transistor. In an embodiment, the partially fabricated interferometric modulator fabricated by the method is an unreleased interferometric modulator. Another embodiment provides an unreleased interferometric modulator made by such a method.

Another embodiment provides a method of manufacturing a plurality of partially fabricated interferometric modulators that includes depositing a first electrode onto a glass substrate, the first electrode being substantially free of indium tin oxide; and depositing an insulating layer onto the first electrode. The method of this embodiment further includes depositing a sacrificial layer onto the insulating layer; and depositing a second electrode onto the sacrificial layer. In this embodiment, the first electrode is patterned into rows and the second electrode is patterned into columns that overlap the rows, the rows and columns having an overlap area of at least about 50%. Another embodiment provides an array of interferometric modulators made by such a method. Another embodiment provides a display device that includes such an array of interferometric modulators. The display device of this embodiment further includes a processor that is in electrical communication with the array, the processor being configured to process image data; and a memory device in electrical communication with the processor.

These and other embodiments are described in greater detail below.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a flow diagram illustrating certain steps in an embodiment of a method of making an interferometric modulator.

FIG. 9 is a flow diagram illustrating an embodiment of a MEMS manufacturing process.

FIG. 10 is a flow diagram illustrating an embodiment of a method of making an interferometric modulator.

FIG. 11 is a flow diagram illustrating an embodiment of a method of making an interferometric modulator.

FIGS. 12a through 12h schematically illustrate an embodiment of a method for fabricating an interferometric modulator using thin film transistor process steps.

FIGS. 13a through 13o schematically illustrate an embodiment of a method for fabricating an interferometric modulator using thin film transistor process steps.

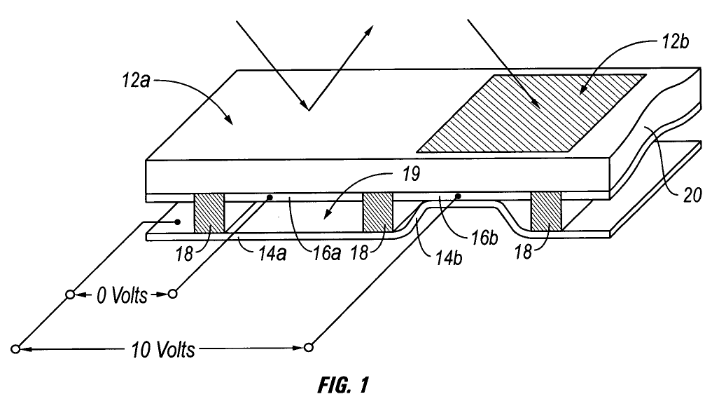

FIGS. 1 to 13 are not to scale.

### DETAILED DESCRIPTION OF PREFERRED EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

An embodiment provides methods of making interferometric modulators using thin film transistor manufacturing techniques.

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. In some embodiments, the layers are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

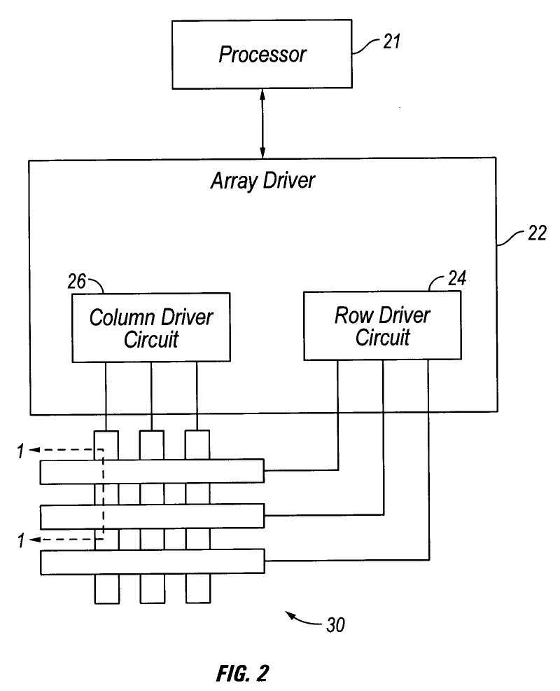

FIGS. 2 through 5 illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

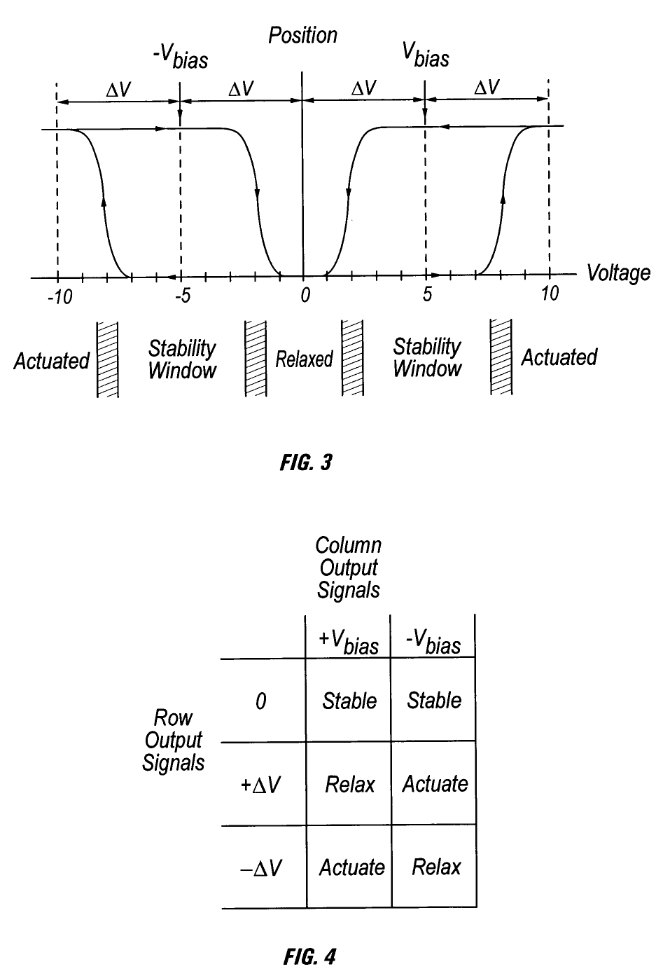

In one embodiment, the processor 21 is also configured to communicate with an array driver 22. In one embodiment, the array driver 22 includes a row driver circuit 24 and a column driver circuit 26 that provide signals to a panel or display array (display) 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

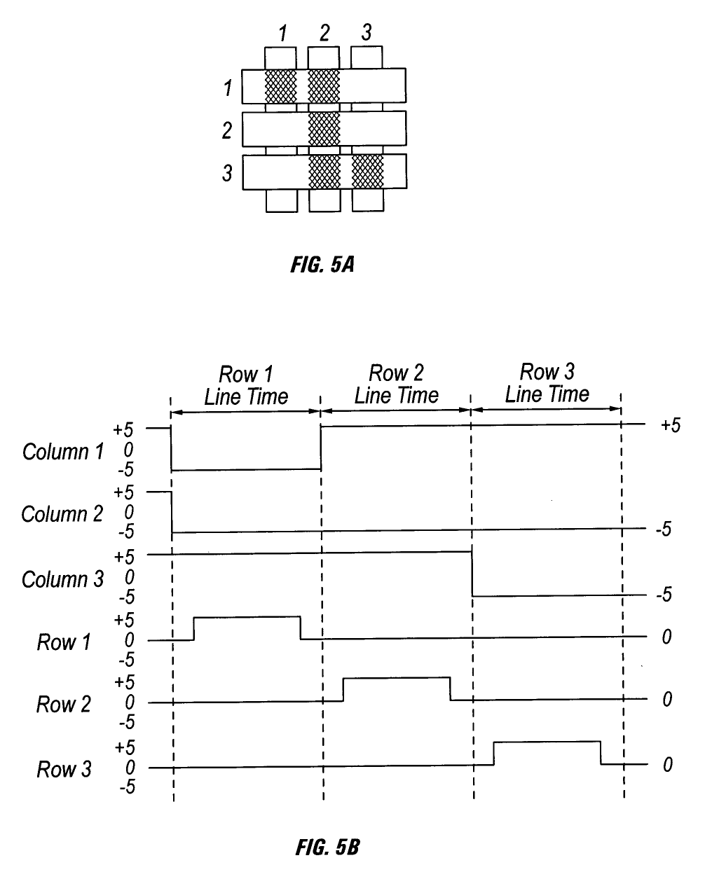

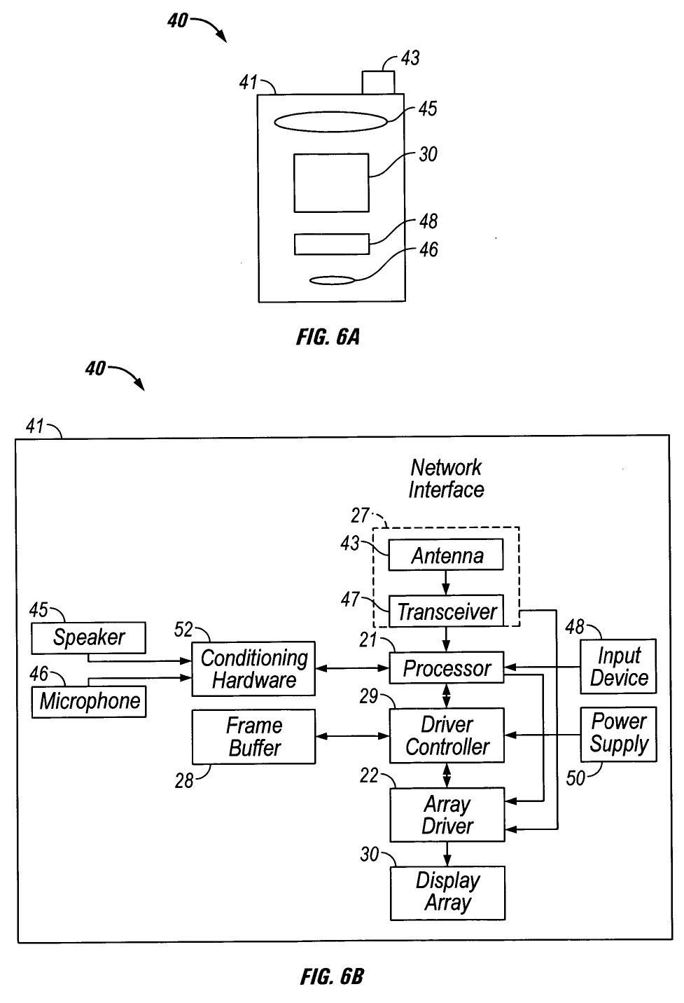

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively. Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

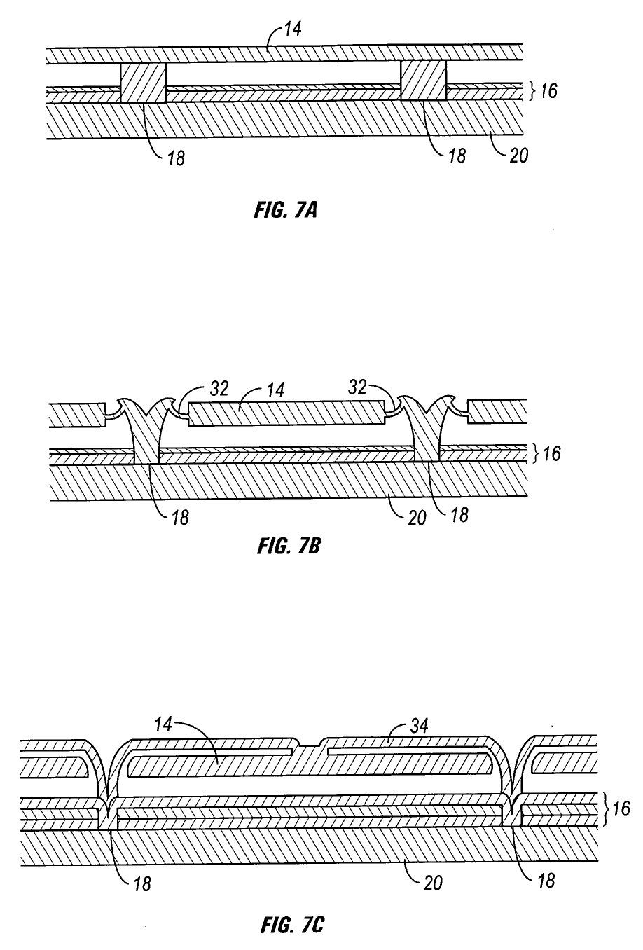

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, a microphone 46 and an input device 48. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of the exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of the exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to the processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28 and to the array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, the network interface 27 can be replaced by an image source, which can store or generate image data to be sent to the processor 21. For example, the image source can be a digital video disc (DVD) or a hard-disc drive that contains image data, or a software module that generates image data.

The processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to the frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. The conditioning hardware 52 generally includes amplifiers and filters for transmitting signals to the speaker 45, and for receiving signals from the microphone 46. The conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, the driver controller 29 is a conventional display controller or a bi-stable display controller (e.g., an interferometric modulator controller). In another embodiment, the array driver 22 is a conventional driver or a bi-stable display driver (e.g., an interferometric modulator display). In one embodiment, the driver controller 29 is integrated with the array driver 22. Such an embodiment is common in highly integrated systems such as cellular phones, watches, and other small area displays. In yet another embodiment, the display array 30 is a typical display array or a bi-stable display array (e.g., a display including an array of interferometric modulators).

The input device 48 allows a user to control the operation of the exemplary display device 40. In one embodiment, the input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

The power supply 50 can include a variety of energy storage devices as are well known in the art. For example, in one embodiment, the power supply 50 is a rechargeable battery, such as a nickel-cadmium battery or a lithium ion battery. In another embodiment, the power supply 50 is a renewable energy source, a capacitor, or a solar cell, including a plastic solar cell, and solar-cell paint. In another embodiment, the power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

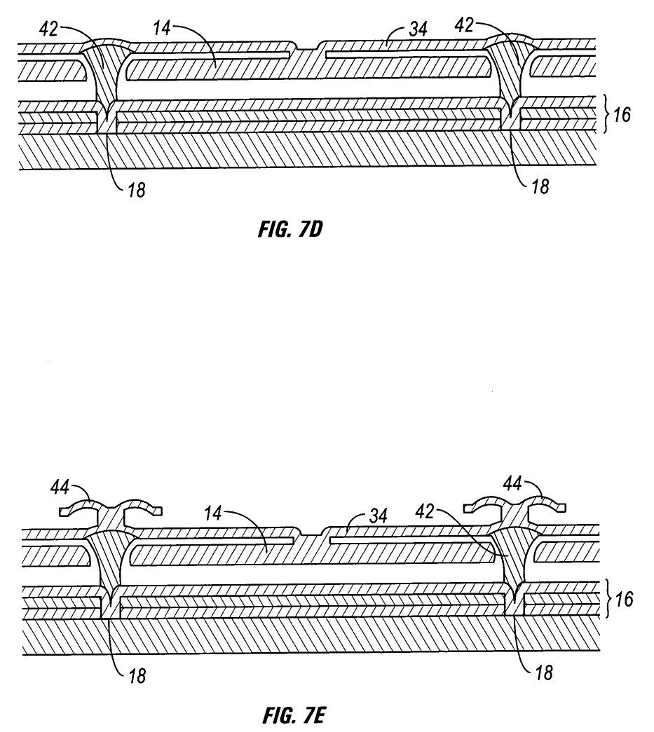

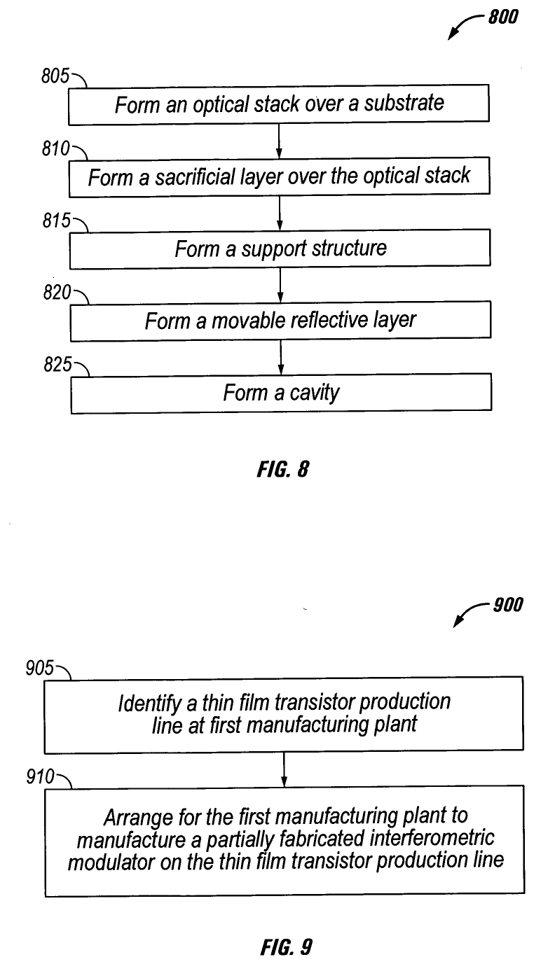

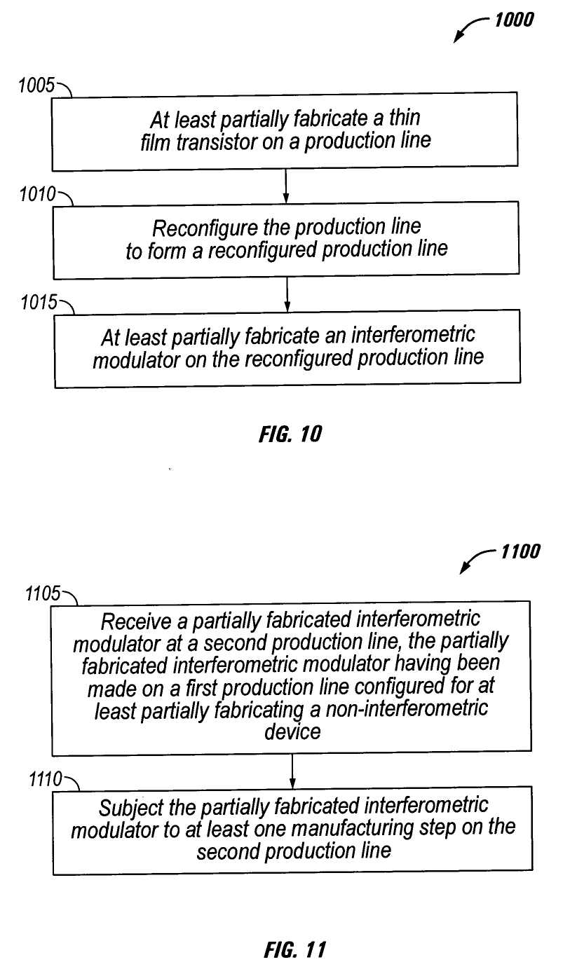

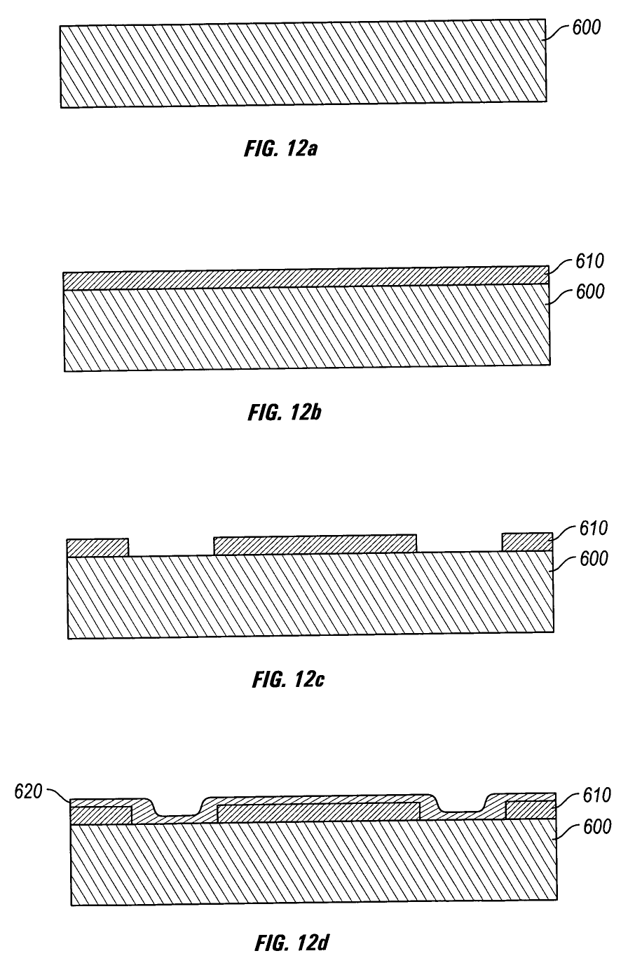

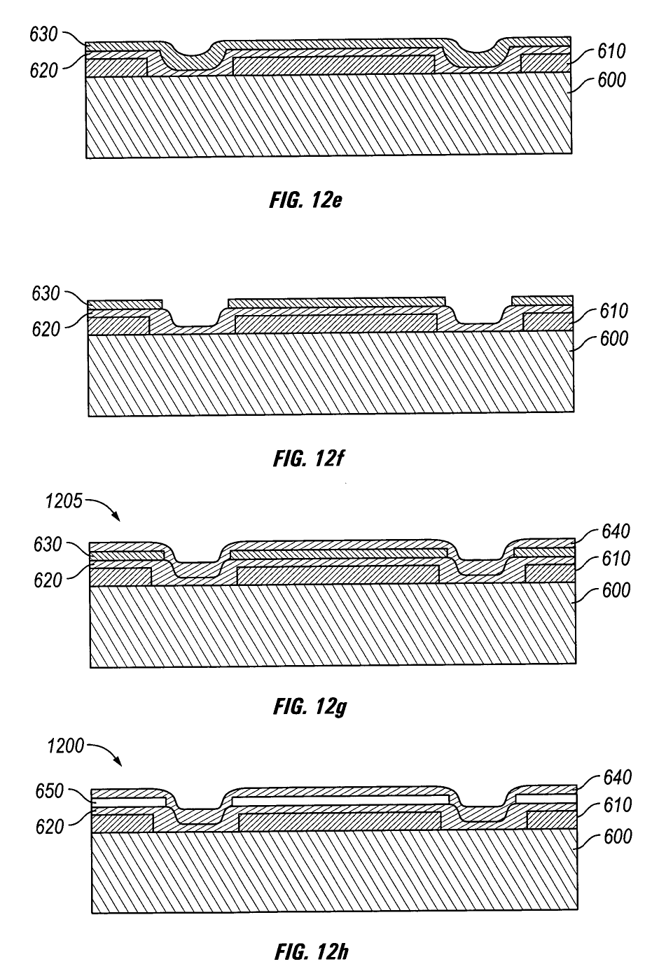

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the movable reflective layer 14 is attached to supports at the corners only, on tethers 32. In FIG. 7C, the movable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support structures 18 that include support post plugs 42 upon which the deformable layer 34 rests. The movable reflective layer 14 remains suspended over the cavity, as in FIGS. 7A-7C, but the deformable layer 34 does not form the support posts 18 by filling holes between the deformable layer 34 and the optical stack 16. Rather, the support posts 18 comprise a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields some portions of the interferometric modulator on the side of the reflective layer opposite the substrate 20, including the deformable layer 34 and the bus structure 44 (FIG. 7E). This allows the shielded areas to be configured and operated upon without negatively affecting the image quality. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

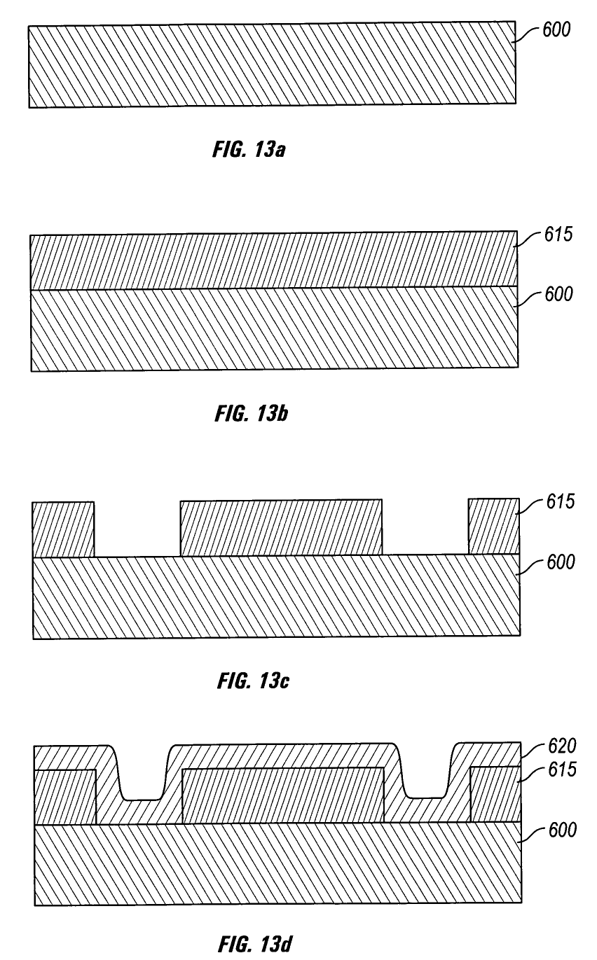

FIG. 8 illustrates certain steps in an embodiment of a manufacturing process 800 for an interferometric modulator. Such steps may be present in a process for manufacturing, e.g., interferometric modulators of the general type illustrated in FIGS. 1 and 7, along with other steps not shown in FIG. 8. With reference to FIGS. 1, 7 and 8, the process 800 begins at step 805 with the formation of the optical stack 16 over the substrate 20. The substrate 20 may be a transparent substrate such as glass or plastic and may have been subjected to prior preparation step(s), e.g., cleaning, to facilitate efficient formation of the optical stack 16. As discussed above, the optical stack 16 is electrically conductive, partially transparent and partially reflective, and may be fabricated, for example, by depositing one or more of the layers onto the transparent substrate 20. In some embodiments, the layers are patterned into parallel strips, and may form row electrodes in a display device. In some embodiments, the optical stack 16 includes an insulating or dielectric layer that is deposited over one or more metal layers (e.g., reflective and/or conductive layers).

The process 800 illustrated in FIG. 8 continues at step 810 with the formation of a sacrificial layer over the optical stack 16. The sacrificial layer is later removed (e.g., at step 825) to form the cavity 19 as discussed below and thus the sacrificial layer is not shown in the resulting interferometric modulator 12 illustrated in FIGS. 1 and 7. The formation of the sacrificial layer over the optical stack 16 may include deposition of a material such as molybdenum or amorphous silicon, in a thickness selected to provide, after subsequent removal, a cavity 19 having the desired size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 800 illustrated in FIG. 8 continues at step 815 with the formation of a support structure e.g., a post 18 as illustrated in FIGS. 1 and 7. The formation of the post 18 may include the steps of patterning the sacrificial layer to form an aperture, then depositing a material (e.g., a polymer) into the aperture to form the post 18, using a deposition method such as PECVD, thermal CVD, or spin-coating. In some embodiments, the aperture formed in the sacrificial layer extends through both the sacrificial layer and the optical stack 16 to the underlying substrate 20, so that the lower end of the post 18 contacts the substrate 20 as illustrated in FIG. 7A. In other embodiments, the aperture formed in the sacrificial layer extends through the sacrificial layer, but not through the optical stack 16. For example, FIG. 7C illustrates the lower end of the support post plugs 42 in contact with the optical stack 16.

The process 800 illustrated in FIG. 8 continues at step 820 with the formation of a movable reflective layer such as the movable reflective layer 14 illustrated in FIGS. 1 and 7. The movable reflective layer 14 may be formed by employing one or more deposition steps, e.g., reflective layer (e.g., aluminum, aluminum alloy) deposition, along with one or more patterning, masking, and/or etching steps. Since the sacrificial layer is still present in the partially fabricated interferometric modulator formed at step 820 of the process 800, the movable reflective layer 14 is typically not movable at this stage. A partially fabricated interferometric modulator that contains a sacrificial layer may be referred to herein as an “unreleased” interferometric modulator.

The process 800 illustrated in FIG. 8 continues at step 825 with the formation of a cavity, e.g., a cavity 19 as illustrated in FIGS. 1 and 7. The cavity 19 may be formed by exposing the sacrificial material (deposited at step 810) to an etchant. For example, a sacrificial material such as molybdenum or amorphous silicon may be removed by dry chemical etching, e.g., by exposing the sacrificial layer to a gaseous or vaporous etchant, such as vapors derived from solid xenon difluoride (XeF₂) for a period of time that is effective to remove the desired amount of material, typically selectively relative to the structures surrounding the cavity 19. Other etching methods, e.g. wet etching and/or plasma etching, may be also be used. Since the sacrificial layer is removed during step 825 of the process 800, the movable reflective layer 14 is typically movable after this stage. After removal of the sacrificial material, the resulting fully or partially fabricated interferometric modulator may be referred to herein as a “released” interferometric modulator.

Thin film transistors (TFT's) are transistors in which the channel region of the transistor is formed by depositing a semiconductor over a base substrate (with appropriate patterning to define the channel region) and in which the base substrate is a non-semiconductor substrate. See, e.g., “Thin Film Transistors—Materials and Processes—Volume 1 Amorphous Silicon Thin Film Transistors,” ed. Yue Kuo, Kluwer Academic Publishers, Boston (2004). The base substrate over which the TFT is formed may be a non-semiconductor such as glass, plastic or metal. The semiconductor that is deposited to form the channel region of the TFT may comprise silicon (e.g., a-Si, a-SiH) and/or germanium (e.g., a-Ge, a-GeH), and may also comprise dopants such as phosphorous, arsenic, antimony, and indium.

It has now been recognized that there are aspects of certain manufacturing processes for making TFT's that are similar in many respects to aspects of certain manufacturing process for making interferometric modulators. For example, Table 1 illustrates aspects of selected process steps that are common to both a TFT manufacturing process and an interferometric modulator. For the embodiments illustrated in Table 1, the process steps are similar, but are typically conducted for different purposes. The first process step, depositing a metal layer onto a non-semiconductor substrate, may be conducted for the purpose of forming a gate metal layer in the TFT process, whereas it may be conducted for the purpose of forming a first conductive/reflective layer (e.g., part of the optical stack 16 as described above for step 805 in FIG. 8) in the interferometric modulator process. Other aspects of the respective processes are different. For example, the TFT and interferometric modulator processes may include a patterning step in which the metal gate layer (TFT) is patterned differently from the first conductive/reflective layer (interferometric modulator).

TABLE 1

| | | | Interferometric |
|---|---|---|---|
| No. | Process step | TFT | Modulator |
| 1 | Deposit metal | Form gate | Form first |
| | layer onto | metal layer on | conductive/ |
| | non-semi- | substrate | reflective |
| | conductor | metal layer | |
| | substrate | | on substrate |
| 2 | Deposit insulating | Form gate | Form dielectric |
| | layer onto | dielectric | layer of |
| | metal layer | layer | optical stack |
| 3 | Deposit semi- | Form channel | Form sacrificial |
| | conductor layer | layer | layer |
| | onto insulating | | |
| | layer | | |
| 4 | Deposit metal | Form channel | Form second |
| | layer onto | etch stop | conductive/ |
| | semiconductor | metal layer/ | reflective |
| | layer | source and | metal layer |
| | | drain | on sacrificial |
| | | electrodes | layer |

The second process step illustrated in Table 1, depositing an insulating layer onto the metal layer, may be conducted for the purpose of forming a gate dielectric layer in the TFT process, whereas it may be conducted for the purpose of forming part of the optical stack (e.g., the dielectric layer part of the optical stack 16 as described above for step 805 in FIG. 8) in the interferometric modulator process. The third process step illustrated in Table 1, depositing a semiconductor layer onto the insulating layer, may be conducted for the purpose of forming a channel layer in the TFT process, whereas it may be conducted for the purpose of forming a sacrificial layer (e.g., as described above for step 810 in FIG. 8) in the interferometric modulator process. The TFT and interferometric modulator processes may include a patterning step in which the channel layer (TFT) is patterned differently from the sacrificial layer (interferometric modulator), e.g., to form apertures in the sacrificial layer as described above for step 815 in FIG. 8.

The fourth process step illustrated in Table 1, depositing a metal layer onto the semiconductor layer, may be conducted for the purpose of forming a channel etch stop metal layer and/or source and drain electrodes in the TFT process, whereas it may be conducted for the purpose of forming a second conductive/reflective metal layer (e.g., the movable reflective layer 14 as described above for step 820 in FIG. 8) in the interferometric modulator process. The TFT and interferometric modulator processes may include a patterning step in which the channel etch stop metal layer (TFT) is patterned differently from the second conductive/reflective metal layer (interferometric modulator).

Table 1 summarizes various aspects of certain manufacturing processes for making TFT's that are similar in many respects to aspects of certain manufacturing process for making interferometric modulators. Various other aspects of the two processes may be different, in some cases significantly different. For example, the thicknesses of the layers deposited during TFT process steps 1-4 (Table 1) may be quite different from the thicknesses of the layers deposited during the corresponding interferometric modulator process steps 1-4. The patterning of each of layers deposited during TFT process steps 1-4 may also be significantly different from the patterning of the layers deposited during the corresponding interferometric modulator process steps 1-4. In an embodiment, the first electrode (e.g., the first conductive/reflective metal layer deposited during the first interferometric modulator process step) is patterned into rows and the second electrode (e.g., the second conductive/reflective metal layer deposited during the fourth interferometric modulator process step) is patterned into columns that overlap the rows, the rows and columns having an overlap area of at least about 50%, preferably at least about 70%. In contrast, TFT's are typically fabricated in such as way as to minimize the overlap area of the gate metal layer (TFT process step 1) and the channel etch stop metal layer (TFT process step 4).

It has now been recognized that MEMS devices (such as interferometric modulators) may be at least partially fabricated on a TFT production line. For example, in an embodiment, an interferometric modulator is fabricated using TFT process steps. This may enable the interferometric modulator to be fabricated at low cost using conventional equipment and process steps designed for the manufacture of TFT's in relatively high volume at relatively low cost.

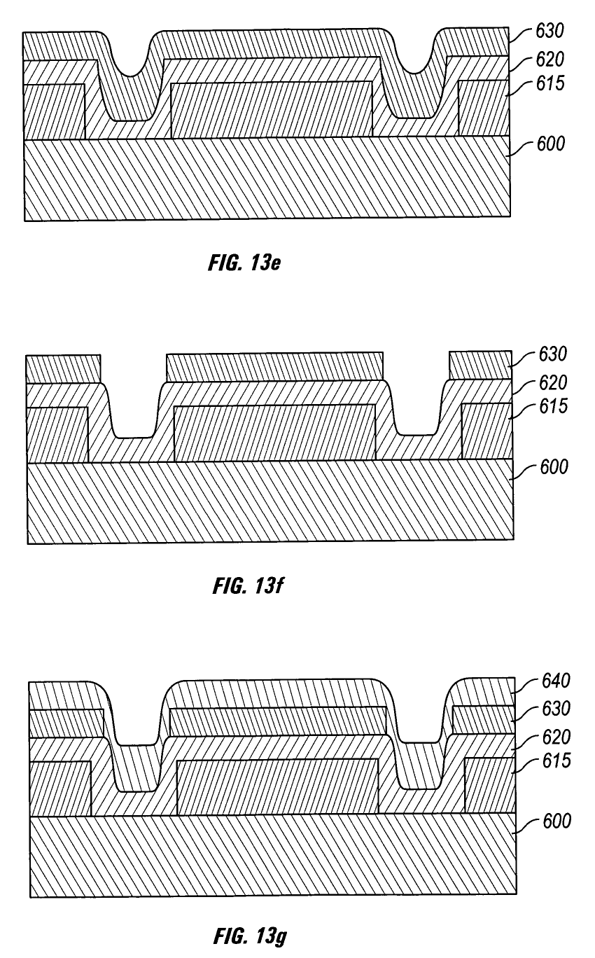

FIG. 9 illustrates an embodiment of a MEMS manufacturing process 900 that may be used to make, e.g., an interferometric modulator. The process 900 begins at step 905 by identifying a TFT production line at a first manufacturing plant. The term “production line” as used herein has its ordinary meaning and thus includes, for example, one or more pieces of equipment configured to produce a particular item or items. A TFT production line may include, for example, deposition and/or patterning equipment configured to produce intermediate products and TFT's by the process 800 discussed above. The TFT production line at the first manufacturing plant may be identified in various ways, e.g., by reputation, by examining TFT products made in the first manufacturing plant, by receiving inquiries from the first manufacturing plant, by contacting the first manufacturing plant, etc. The identification of the TFT production line at a first manufacturing plant may be carried out in various ways, e.g., by personal inspection of the TFT production line, by voice, telephone, mail, fax, e-mail, internet, by discussion with others who have reviewed and/or inspected the TFT production line, etc. Various entities may cooperate together to identify the TFT production line at the first manufacturing plant.

In the process 900, the TFT production line at the first manufacturing plant is preferably configured in such a way as to be relatively easily modified for the production of a MEMS device. For example, in an embodiment, the TFT production line is configured to produce a TFT configured for a flat panel display. In another embodiment, the TFT production line is configured to deposit a metal layer (e.g., a metal layer comprising chromium, molybdenum or aluminum), e.g., as discussed above with respect to the first and fourth steps in Table 1. For example, the TFT production line may be configured to deposit a metal layer (e.g., a metal layer comprising chromium, molybdenum, and/or aluminum) onto a glass substrate and/or insulating layer.

In another embodiment, the TFT production line at the first manufacturing plant in the process 900 is configured to deposit an insulating layer (such as an insulating layer comprising a silicon oxide or a silicon nitride), e.g., configured to deposit the insulating layer onto the first metal layer as discussed above with respect to the second step in Table 1. In another embodiment, the TFT production line is configured to deposit a semiconductor layer (such as a layer comprising amorphous silicon), e.g., configured to deposit the metallic or semiconductor layer onto the insulating layer as discussed above with respect to the third step in Table 1.

The process 900 continues at step 910 by arranging for the first manufacturing plant to manufacture a partially fabricated interferometric modulator on the TFT production line. Such manufacturing arrangements may be made in various ways. For example, in an embodiment, the operators or directors of the TFT production line at the first manufacturing plant may provide the manufacturing arrangements. In another embodiment, a third party (e.g., MEMS designer) identifies the TFT product line at the first manufacturing plant and transmits a request (e.g., purchase order, request to prepare a sample, request to prepare a model) to the first manufacturing plant to modify the thin film transistor production line to make it suitable for carrying out one or more steps in the fabrication of an interferometric modulator. The manufacturing arrangements may be carried out in various ways, e.g., by voice, telephone, mail, fax, e-mail, internet, by discussion with others who are tasked with carrying out the details of the arrangements, etc. Various entities may cooperate together to arrange for the first manufacturing plant to manufacture a partially fabricated interferometric modulator (e.g., an unreleased interferometric modulator) on the TFT production line.

The manufacturing arrangements may include suggestions or directions for process modifications, e.g., to modify one or more TFT patterning steps to make them more suitable for one or more interferometric modulator patterning steps e.g., as discussed above with respect to the steps illustrated in Table 1. The modifications are preferably relatively minor, e.g., so that the at least some of the process steps are conducted in the same sequence, but with different instructions (e.g., different layer thickness and/or patterning) for each of the steps. The operators or directors of the TFT production line at the first manufacturing plant need not be aware of the purpose of the manufacturing arrangements. For example, in some embodiments it may not be necessary for the operators or directors of the TFT production line at the first manufacturing plant to be aware that the manufacturing arrangements (provided by, e.g., a third party MEMS designer identifying the TFT product line at the first manufacturing plant) are suitable for manufacturing a partially fabricated interferometric modulator on the thin film transistor production line. Various parties may cooperate together to make the manufacturing arrangements.

In another embodiment (not illustrated in FIG. 9), the MEMS manufacturing process 900 further comprises arranging for the partially fabricated interferometric modulator to be moved to a second manufacturing plant. Such moving arrangements may be carried out in various ways, e.g., by the operators or directors of the TFT production line at the first manufacturing plant; by a third party; and/or by the entity identifying the TFT product line (e.g., in step 905) at the first manufacturing plant. In another embodiment (not illustrated in FIG. 9), the MEMS manufacturing process 900 further comprises arranging for the second manufacturing plant to conduct at least one manufacturing step on the partially fabricated interferometric modulator. For example, in an embodiment, the at least one manufacturing step comprises a release step, e.g., a step in which a sacrificial layer is removed from a MEMS device such as the interferometric modulator. The moving and further manufacturing arrangements may take various forms and may be carried out in various ways, as generally discussed above with respect to identifying the TFT production line and arranging for it to manufacture partially fabricated interferometric modulators.

The MEMS manufacturing process 900 may be used to produce a partially fabricated interferometric modulator, e.g., an unreleased interferometric modulator. An embodiment provides a partially fabricated interferometric modulator made by such a process. The MEMS manufacturing process 900 may comprise further steps such as moving the partially fabricated interferometric modulator to a second manufacturing plant and, optionally, arranging for the second manufacturing plant to conduct at least one manufacturing step (such as a release step) on the partially fabricated interferometric modulator as discussed above. Thus, the MEMS manufacturing process 900 may be used to fabricate an interferometric modulator. An embodiment provides an interferometric modulator made by such a process.

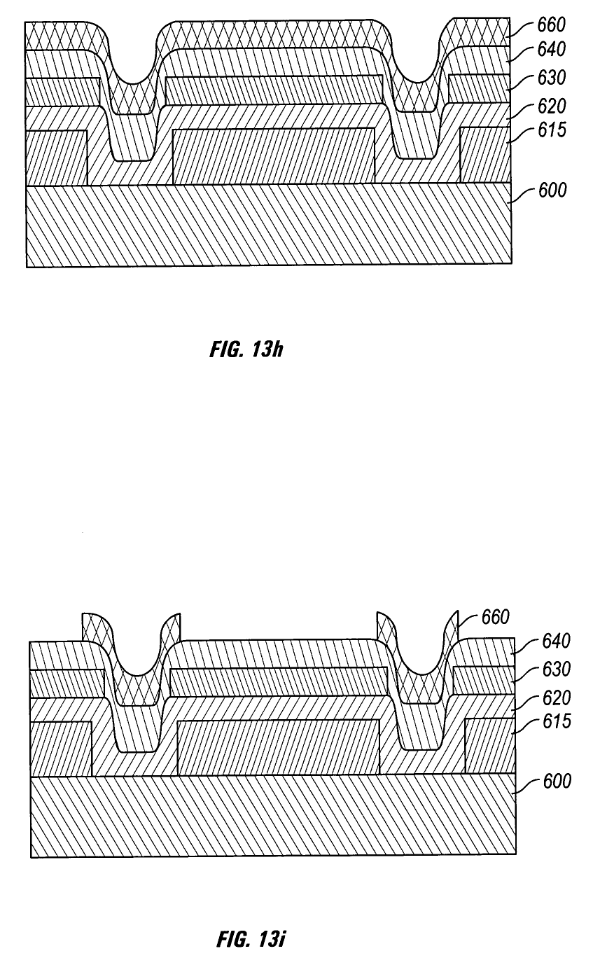

FIG. 10 illustrates another embodiment, a method 1000 of making an interferometric modulator. The method 1000 begins at step 1005 by at least partially fabricating a TFT on a production line, e.g., on a TFT production line at a manufacturing plant. In an embodiment, the TFT is configured for manufacturing a flat panel display. The production line preferably shares at least one feature, preferably two or more features, more preferably three or more features, in common with an interferometric modulator production line. For example, in an embodiment, the production line has three or four of the process steps, such as metal, dielectric and semiconductor deposition and patterning, illustrated in Table 1 in common with an interferometric modulator process.

The method 1000 continues at step 1010 by reconfiguring the production line to form a reconfigured production line. The production line may be re-configured in various ways, e.g., the additional processing steps may be added, existing process steps may be eliminated, the processing parameters for existing process parameters may be modified, etc. In an embodiment, the production line prior to reconfiguration shares at least one feature, preferably two or more features, more preferably three or more features, in common with an interferometric modulator production line, most preferably with common process steps in the same sequence. In an embodiment, the production line is re-configured to modify one or more TFT patterning steps to make them more suitable for one or more interferometric modulator patterning steps e.g., as discussed above with respect to the steps illustrated in Table 1. In an embodiment, reconfiguration comprises changing the thicknesses and patterning of each of the deposition steps illustrated in FIG. 1, while preserving the order and/or the materials deposited in each step. In a preferred embodiment, reconfiguration does not require significant changes in or to the deposition equipment.

The method 1000 continues at step 1015 by at least partially fabricating an interferometric modulator on the reconfigured production line. Fabrication of the interferometric modulator on the reconfigured production line may be carried out in various ways. In an embodiment, such fabrication is carried out by conducting one or more, preferably two or more, more preferably three or more, of the interferometric modulator process steps illustrated in Table 1. The partially fabricated interferometric modulator made by the method 1000 may be an unreleased interferometric modulator. Thus, an embodiment provides an unreleased interferometric modulator made by the method 1000.

The method 1000 may comprise further steps such as shipping the partially fabricated interferometric modulator, e.g., shipping the unreleased interferometric modulator. For example, the partially fabricated interferometric modulator may be shipped to a second manufacturing plant and, optionally, the second manufacturing plant may conduct at least one manufacturing step (such as a release step) on the partially fabricated interferometric modulator as discussed above. Thus, the method 1000 may be used to fabricate an interferometric modulator. An embodiment provides an interferometric modulator made by such a method.

In another embodiment (not illustrated in FIG. 10), a method for making an interferometric modulator comprises fabricating a partially fabricated interferometric modulator on a reconfigured production line, the reconfigured production line having been previously configured for at least partially fabricating a thin film transistor. Such a method may further comprise shipping the partially fabricated interferometric modulator, e.g., an unreleased interferometric modulator. In an embodiment, the unreleased interferometric modulator is shipped to a second production line configured to carry out a release step on the unreleased interferometric modulator.

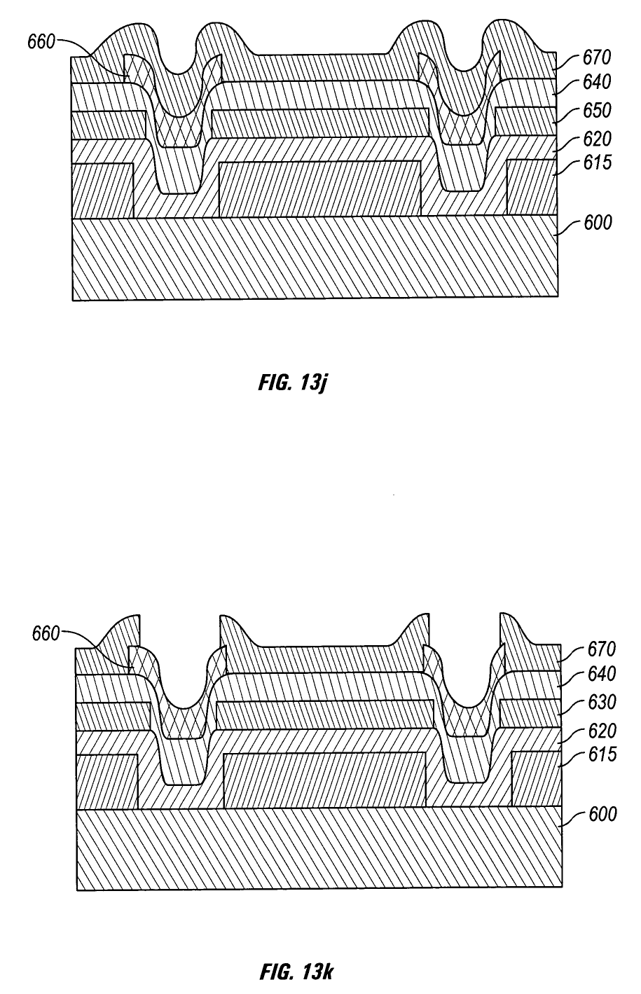

FIG. 11 illustrates another embodiment, a method 1100 of making an interferometric modulator. The method 1100 begins at step 1105 by receiving a partially fabricated interferometric modulator at a second production line. The partially fabricated interferometric modulator is one that has been fabricated on a first production line configured for at least partially fabricating a non-interferometric device. For example, in an embodiment, the first production line may be a dual use production line configured to at least partially produce a TFT and also configured to at least partially produce an interferometric modulator. In another embodiment, the first production line was previously configured to produce a non-interferometric device (such as a TFT), then was re-configured to form a reconfigured production line suitable for at least partially fabricating an interferometric modulator as discussed above with respect to the method 1000 illustrated in FIG. 10. In an embodiment, the reconfiguration comprises changing the thicknesses and patterning of each of the deposition steps, e.g., as illustrated in FIG. 1, while carrying out the deposition steps in the same order. In a preferred embodiment, reconfiguration does not require significant changes to the deposition equipment. Receiving the partially fabricated interferometric modulator at the second production line at step 1105 may comprise receiving a partially fabricated interferometric modulator shipped from the re-configured production line of the method 1000.

The method 1100 continues at step 1110 by subjecting the partially fabricated interferometric modulator to at least one manufacturing step on the second production line. In an embodiment, the partially fabricated interferometric modulator is an unreleased interferometric modulator, and the at least one manufacturing step on the second production line comprises a release step in which the sacrificial material is etched away to form a cavity. Thus, the method 1100 may be used to fabricate an interferometric modulator. An embodiment provides an interferometric modulator made by such a method.

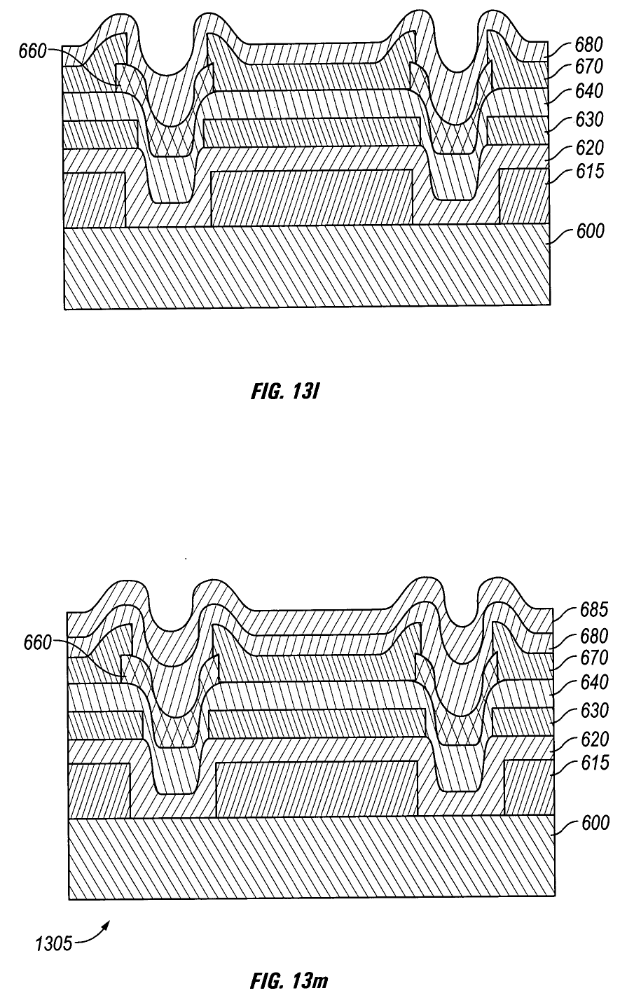

FIGS. 12a through 12h schematically illustrate an embodiment of a method for fabricating an interferometric modulator using TFT fabrication process steps. Referring now to FIG. 12h, an embodiment of an interferometric modulator 1200 is depicted schematically in cross section. The interferometric modulator includes a glass substrate 600, a thin chromium layer 610 as the first electrode, a silicon nitride insulating layer 620, and an aluminum layer 640 as the flexible second electrode. In operation, the cavities 650 of the interferometric modulator are designed to be viewed through the glass substrate 600 into the deposited layers.

The interferometric modulator embodiment of FIG. 12h may be fabricated as follows. The glass substrate 600, as depicted in FIG. 12a, is cleaned using standard procedures. While a glass substrate is preferably employed, other substrates are also suitable for use, e.g., as disclosed in U.S. Pat. No. 5,835,255. The substrate is coated with a thin chromium layer 610, depicted in FIG. 12b. The thin chromium layer 610 is deposited using a deposition method as conventionally employed in thin film transistor fabrication processes, e.g., physical vapor deposition methods such as sputtering or e-beam evaporation, chemical vapor deposition, or molecular beam epitaxy. In order for the interferometric modulator to possess satisfactory optical characteristics, the chromium layer is preferably from about 50 Å to about 100 Å in thickness.

The thin chromium layer 610 is then patterned, as depicted in FIG. 12c, using a patterning method as conventionally employed in thin film transistor fabrication processes, e.g., photoresist mask formation followed by a wet chemical etching process or by plasma or reactive ion etching. Alternatively, a lift-off procedure can be employed. The patterned thin chromium layer 610 forms the set of first electrodes. Typical dimensions of the first electrodes are from about 10 μm to about 250 μm in width.

After the thin chromium layer 610 has been patterned, a silicon nitride insulating layer 620 is deposited, as depicted in FIG. 12d. The silicon nitride layer 620 may be deposited using a deposition method as conventionally employed in thin film transistor fabrication processes, such as low pressure CVD (LPCVD), plasma-enhanced CVD (PECVD), laser assisted photo CVD, ion implanting, or DC or RF sputtering. The silicon nitride layer 620 is preferably from about 700 Å to about 2500 Å in thickness.

A layer of silicon 630 (e.g., a-SiH) is then deposited on the silicon nitride layer 620, as depicted in FIG. 12e. The silicon layer 630 is then patterned, as depicted in FIG. 12f, using methods as conventionally employed in thin film transistor fabrication processes. The patterned silicon layer 630 may be referred to as a sacrificial layer.

An aluminum layer 640 is then deposited over the sacrificial layer (the patterned silicon layer 630) and the exposed portions of the silicon nitride layer 620, as depicted in FIG. 12g. The aluminum layer 640 may deposited using any suitable method, such as described above for the deposition of the thin chromium layer 610. The aluminum layer 640 is then patterned (not illustrated in FIG. 12) using a patterning method as conventionally employed in thin film transistor fabrication processes, such as described above, to form the set of flexible second electrodes. The thickness of the aluminum layer is preferably from about 500 Å to about 3500 Å. Aluminum alloys are particularly preferred for use in preparing the aluminum layer 640, for example, Al—Nd, Al—Si, and Al—Cu, alloys. However, any suitable aluminum-containing material can be employed.

The sequence of steps depicted in FIGS. 12a through 12g parallel those conventionally employed in standard TFT fabrication processes, and result in the unreleased interferometric modulator 1205 depicted in FIG. 12g. After these steps are conducted, the sacrificial silicon layer 630 may be removed to form the cavities 650 as depicted in FIG. 12h. The removal of the sacrificial layer 630 may be conducted on the TFT production line. Preferably, however, the unreleased interferometric modulator 1205 is moved or shipped to a second facility or production line configured to carry out the release step, as discussed above. The sacrificial silicon layer 630 may be removed using a dry etch process that is selective against the surrounding materials. Dry etching processes are particularly preferred and offer a number of advantages over other etching methods (e.g., wet etching), e.g., use of dangerous acids and solvents may be avoided and process control may be better than with wet etching.

Any suitable selective etching process may be employed, including non-plasma as well as plasma based processes. The etching process is preferably selective against chromium aluminum, aluminum alloys, and silicon nitride. Non-plasma based dry etching processes are preferred for etching silicon. Fluorine-containing gases, such as fluorides or interhalogens, are typically employed. Non-plasma based dry etch processes avoid the need for plasma processing equipment, and may be tightly controlled via temperature and partial pressure of the reactants employed. A particularly preferred fluorine-containing gas for use in non-plasma based dry etching is the vapor derived from solid xenon difluoride (XeF₂). Xenon difluoride reacts with silicon to form silicon tetrafluoride. Etch rates of from about 1 to about 3 μm/min are typical for etching with xenon difluoride. Alternatively, an interhalogen gas can be employed, e.g., bromine trifluoride or chlorine trifluoride. These gases also react with silicon to form silicon tetrafluoride.

While non-plasma based dry etching with xenon difluoride is particularly preferred for removing the sacrificial amorphous silicon layer 630, other dry etching methods may also be employed. Plasma based dry etching employs RF power to drive the chemical reactions involved in the etch process. Use of plasma avoids the need for elevated temperatures and highly reactive chemicals in the etch process. Plasma based dry etching methods may employ physical etching, chemical etching, reactive ion etching (RIE), and/or deep reactive ion etching (DRIE).

Removal of the sacrificial amorphous silicon layer 630 results in the formation of cavities 650 between the chromium and aluminum electrodes 610, 640. The cavities 650 permit the flexible aluminum electrodes 640 to deform upon application of a voltage between the chromium and aluminum electrodes 610, 640.

It is noted that in a typical TFT fabrication process, e.g., for flat panel displays, an insulating layer such as a silicon nitride layer is deposited after deposition of a chromium layer, but before deposition of an ITO layer. In an embodiment, an ITO layer is not deposited onto a chromium layer (nor a chromium layer onto an ITO layer) using typical TFT fabrication process steps. Accordingly, in this embodiment, the first electrode is substantially free of ITO. Because the conductivity of an electrode consisting only of a thin (50 Å-100 Å) chromium layer is significantly less than that of an electrode consisting of an ITO layer atop a thin chromium layer, or a thicker chromium layer, the interferometric modulator embodiment 1200 prepared according to the process depicted in FIGS. 12a through 12h tends to be slower to actuate when a voltage is applied to the electrodes. However, for certain applications wherein a fast response time is not necessary, e.g., display of text or static images, the slower actuation time may be acceptable. Advantages of the process depicted in FIGS. 12a through 12h include a limited number of process steps necessary to fabricate the device, resulting in faster fabrication and lower materials cost.

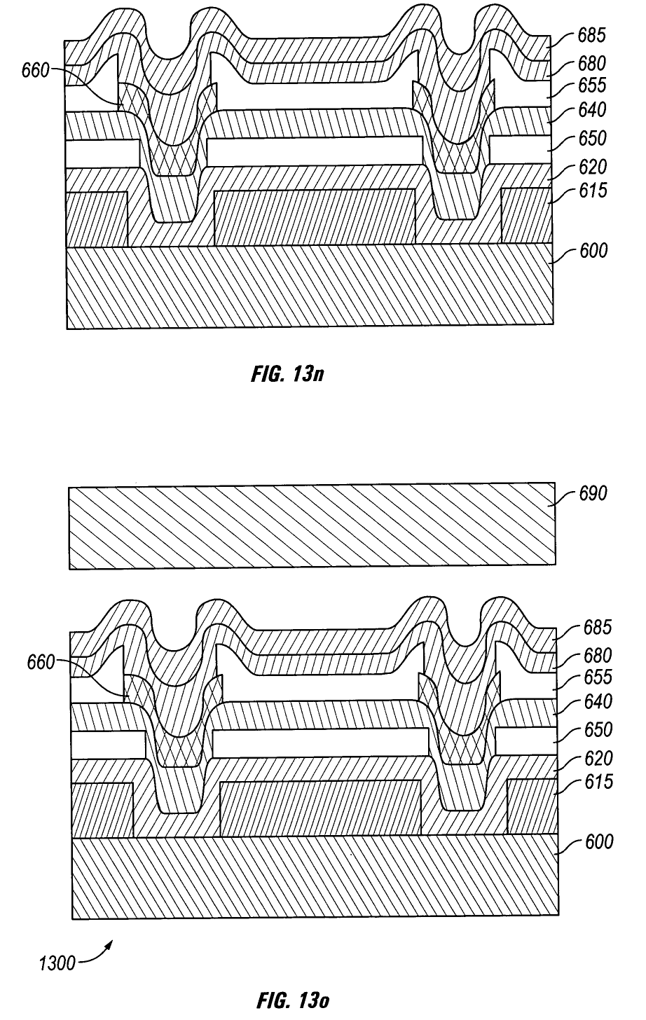

Referring now to FIGS. 13a through 13o, an embodiment of a method of fabricating an interferometric modulator 1300 is illustrated. The interferometric modulator 1300 is depicted schematically in cross section in FIG. 13o. The interferometric modulator 1300 includes a glass substrate 600, a thick chromium layer 615 as the first electrode, a silicon nitride insulating layer 620, an aluminum layer 640 as the flexible second electrode, and a second thin chromium optical layer 680. In operation, the optical cavities 655 of the interferometric modulator are designed to be viewed through a transparent protective layer 690 into the deposited layers, rather than through the glass substrate 600 as in the interferometric modulator depicted in FIG. 12h.

The interferometric modulator 1300 of FIG. 13o may be fabricated using the same initial steps as in the fabrication of the interferometric modulator 1200 of FIG. 12h, with additional steps to form the second thin chromium optical layer 680. The glass substrate 600, as depicted in FIG. 13a, is cleaned using standard procedures. The substrate is then coated with a thick chromium layer 615, as depicted in FIG. 13b. Because the chromium layer 615 does not perform an optical function in this embodiment, it may be made thicker so as to provide improved conductivity and thus faster actuation of the device in operation. The thickness of the chromium layer 615 is preferably from about 500 Å to about 2000 Å.

The thick chromium layer 615 is then patterned, as depicted in FIG. 13c, using a patterning method, as described above in reference to the interferometric modulator 1200, to form the set of first electrodes.

After the thick chromium layer 615 has been patterned, a silicon nitride insulating layer 620 is deposited, as depicted in FIG. 13d. A layer of silicon 630 (e.g., a-Si or a-SiH) is then deposited on the silicon nitride layer 620, as depicted in FIG. 13e. The silicon layer 630 is then patterned, as depicted in FIG. 13f, to form a sacrificial layer. An aluminum layer 640 is then deposited atop the silicon sacrificial 630 and the exposed portions of the silicon nitride layer 620, as depicted in FIG. 13g. The aluminum layer 640 is then patterned (not shown in FIG. 13), as described above in reference to the interferometric modulator 1200, to form the set of flexible second electrodes.

After deposition and patterning of the aluminum layer 640, additional steps are conducted to form the thin chromium optical layer 680 and the cavities 650, 655 of the interferometric modulator embodiment 1300 depicted in FIG. 13o. A second layer of silicon nitride 660 is deposited atop the patterned aluminum layer 640 as depicted in FIG. 13h, and patterned, as depicted in FIG. 13i, using methods as described above for patterning of the first layer of silicon nitride 620.

A molybdenum or silicon layer 670 is then deposited atop the patterned aluminum layer 640 and the second silicon nitride layer 660, as depicted in FIG. 13j. The layer of molybdenum or silicon 670 is then patterned, as depicted in FIG. 13k, using methods such as described for patterning the sacrificial silicon layer 630, to form a second sacrificial layer. Once the mirror/mechanical layer (e.g., the aluminum layer 640) is deposited, it is desirable to avoid processing at high temperatures to protect against hillocking of the aluminum alloy or diffusion of silicon. Thus, it is particularly preferred to deposit the molybdenum or silicon sacrificial layer 670 using a low temperature deposition process, e.g., DC sputter.

A thin chromium layer 680 is then deposited over the patterned sacrificial layer 670 and the exposed portions of the second silicon nitride layer 660, as depicted in FIG. 131. The thin chromium layer 680 may then be patterned (not illustrated in FIG. 13) using a patterning method as described above for patterning the thick chromium layer 615. The patterned thin chromium layer 680 forms an optical layer. In order for the interferometric modulator to possess satisfactory optical characteristics, the chromium layer 680 is preferably from about 50 to about 100 Å in thickness. The thin chromium layer 680 may be too thin and fragile to be employed as a free standing structure. An additional passivation layer 685, e.g., a transparent dielectric material, may be deposited on top of the chromium layer 680 to enhance its structural stability, as depicted in FIG. 13m. Preferably, a low temperature deposition process is employed, e.g., RF sputter from a ceramic target or reactive sputtering from a silicon target. Overall thickness of the chromium layer 680 and the passivation layer 685 is from about 2000 Å to about 10000 Å. The passivation layer 685 and chromium layers 685, 680 may be patterned with etch holes and vents positioned so that the etchant can permeate the structure and remove the sacrificial layers 630, 670. The resulting unreleased interferometric modulator 1305 is depicted in FIG. 13m.

The sequence of steps depicted in FIGS. 13a through 13m parallel process steps conventionally employed in standard TFT fabrication processes. After these steps are conducted, the first sacrificial layer 630 and the second sacrificial layer 670 may be removed during a release step to form cavities 650 and 655, respectively, as depicted in FIG. 13n. The removal of the sacrificial layers 630, 670 may be conducted on the TFT production line. Preferably, the unreleased interferometric modulator 1305 is moved or shipped to a second facility or production line configured to carry out the release step, as discussed above. The sacrificial layers are preferably removed using a selective dry etch process, such as is described above in regard to the removal of the sacrificial layer 630 in the device depicted in FIG. 12g. Removal of the sacrificial layers 630, 670 results in the formation of the first optical cavity 655 between the chromium optical layer 680 and the aluminum electrode 640, and the second optical cavity 650 below the aluminum electrode 640. The cavities 650, 655 permit the flexible aluminum electrode 640 to deform upon application of a voltage between the thick chromium layer 615 and the aluminum electrode 640. A xenon difluoride dry etch is effective for removing both sacrificial layers 650, 655.

In an embodiment, a protective covering 690 may be applied over the deposited layers, with a gap between the protective covering 690 and the topmost deposited layers, e.g., the thin chromium layer 680 and the passivation layer 685, as depicted in FIG. 13o. The protective covering 690 is optically transparent, and preferably comprises glass or a polymeric material. Similar materials as employed for the substrate 600 may be employed for the protective covering 690. As discussed above, in operation, the optical cavities 650, 655 of the interferometric modulator 1300 are designed to be viewed through the transparent protective layer 690 into the deposited layers, rather than through the glass substrate as in the interferometric modulator depicted in FIG. 12h. Accordingly, it is not necessary that the substrate 600 be optically transparent. However, optically transparent substrates are typically convenient to employ, and thus preferred.

Because the first chromium layer 615 in the illustrated interferometric modulator embodiment 1300 does not need to function as an optical layer, only as an electrode layer, it may be made thicker so as to improve the conductivity of the layer. The thicker layer may result in improved response time for the interferometric modulator 1300 upon actuation. Such interferometric modulators are well suited for use in applications wherein a fast actuation time is desirable, e.g., video displays. Advantages of the process depicted in FIGS. 13a through 13o may include, for example, the ability to employ process steps adapted from standard thin film transistor fabrication methods and/or enabling the interferometric modulators to be fabricated at low cost using conventional equipment and processes.

The manufacturing methods described above may be used to make an a plurality (e.g., an array) of partially fabricated interferometric modulators. In an embodiment, a method of manufacturing a plurality of partially fabricated interferometric modulators includes depositing a first electrode onto a glass substrate, e.g., depositing a metal layer 610 as illustrated in FIG. 12b. The first electrode may be substantially free of indium tin oxide as described above with respect to metal layer 610. The method may further include depositing a insulating layer onto the first electrode, e.g., depositing an insulating layer 620 onto the metal layer 610 as illustrated in FIG. 12d. The method may further include depositing a sacrificial layer onto the insulating layer, e.g., depositing a sacrificial layer 630 onto the insulating layer 620 as illustrated in FIG. 12e. The method may further include depositing a second electrode onto the sacrificial layer, e.g., depositing metal layer 640 onto the sacrificial layer 630 as illustrated in FIG. 12g. In this embodiment, the first electrode is preferably patterned into rows and the second electrode is preferably patterned into columns that overlap the rows, the rows and columns having an overlap area of at least about 50%, more preferably at least about 70%. Such a method may be used to fabricate an array of interferometric modulators. Thus, another embodiment provides an array of interferometric modulators may be such a method.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A MEMS manufacturing process, comprising:
identifying a thin film transistor production line at a first manufacturing plant; and
arranging for the first manufacturing plant to manufacture a partially fabricated interferometric modulator on the thin film transistor production line.

2. The MEMS manufacturing process of claim 1, further comprising arranging for the partially fabricated interferometric modulator to be moved to a second manufacturing plant.

3. The MEMS manufacturing process of claim 2, further comprising arranging for the second manufacturing plant to conduct at least one manufacturing step on the partially fabricated interferometric modulator.

4. The MEMS manufacturing process of claim 3, wherein the at least one manufacturing step comprises a release step.

5. The MEMS manufacturing process of claim 1, wherein the partially fabricated interferometric modulator is an unreleased interferometric modulator.

6. The MEMS manufacturing process of claim 1, wherein the thin film transistor production line is configured to produce a thin film transistor configured for a flat panel display.

7. The MEMS manufacturing process of claim 1, wherein the thin film transistor production line is configured to deposit a metal layer on a glass substrate.

8. The MEMS manufacturing process of claim 7, wherein the metal layer comprises chromium or molybdenum.

9. The MEMS manufacturing process of claim 7, wherein the thin film transistor production line is configured to deposit an insulating layer onto the metal layer.

10. The MEMS manufacturing process of claim 9, wherein the insulating layer comprises silicon nitride.

11. The MEMS manufacturing process of claim 9, wherein the thin film transistor production line is configured to deposit a silicon layer onto the insulating layer.

12. The MEMS manufacturing process of claim 11, wherein the silicon layer comprises amorphous silicon.

13. The MEMS manufacturing process of claim 11, wherein the thin film transistor production line is configured to deposit a second metal layer onto the silicon layer.

14. The MEMS manufacturing process of claim 13, wherein the second metal layer comprises aluminum.

15. The MEMS manufacturing process of claim 14, wherein the second metal layer comprises an aluminum alloy.

16. A partially fabricated interferometric modulator made by the MEMS manufacturing process of claim 1.

17. A method of making an interferometric modulator, comprising:
at least partially fabricating a thin film transistor on a production line;
reconfiguring the production line to form a reconfigured production line; and
at least partially fabricating an interferometric modulator on the reconfigured production line.

18. The method of claim 17, wherein at least partially fabricating an interferometric modulator on the reconfigured production line comprises fabricating an unreleased interferometric modulator.

19. The method of claim 17, wherein at least partially fabricating an interferometric modulator on the reconfigured production line comprises a release step.

20. The method of claim 18, further comprising shipping the unreleased interferometric modulator.

21. The method of claim 17, wherein the production line comprises the steps of:
depositing a first metal layer onto a non-semiconductor substrate;
depositing an insulating layer onto the metal layer;
depositing a semiconductor layer onto the insulating layer; and
depositing a second metal layer onto the semiconductor layer.

22. The method of claim 21, wherein the reconfigured production line also comprises the steps of:
depositing the first metal layer onto the non-semiconductor substrate;
depositing the insulating layer onto the metal layer;
depositing the semiconductor layer onto the insulating layer; and
depositing the second metal layer onto the semiconductor layer.

23. The method of claim 22, wherein reconfiguring the production line comprises changing a patterning step.

24. The method of claim 22, wherein reconfiguring the production line comprises changing a layer thickness.

25. A partially fabricated interferometric modulator made by the method of claim 17.

26. A method of making an interferometric modulator, comprising:
receiving a partially fabricated interferometric modulator at a second production line, the partially fabricated interferometric modulator having been made on a first production line configured for at least partially fabricating a non-interferometric device; and
subjecting the partially fabricated interferometric modulator to at least one manufacturing step on the second production line.

27. The method of claim 26, wherein the partially fabricated interferometric modulator is an unreleased interferometric modulator.

28. The method of claim 27, wherein the at least one manufacturing step comprises a release step.

29. The method of claim 26, wherein the non-interferometric device is a thin film transistor.

30. An interferometric modulator made by the method of claim 26.

31. A method for making an interferometric modulator, comprising fabricating a partially fabricated interferometric modulator on a reconfigured production line, the reconfigured production line having been previously configured for at least partially fabricating a thin film transistor.

32. The method of claim 31, further comprising shipping the partially fabricated interferometric modulator.

33. The method of claim 32, wherein the partially fabricated interferometric modulator is an unreleased interferometric modulator.

34. An unreleased interferometric modulator made by the method of claim 33.

35. A method of manufacturing a plurality of partially fabricated interferometric modulators, comprising:
depositing a first electrode onto a glass substrate, the first electrode being substantially free of indium tin oxide;
depositing an insulating layer onto the first electrode, depositing a sacrificial layer onto the insulating layer; and
depositing a second electrode onto the sacrificial layer;
the first electrode being patterned into rows and the second electrode being patterned into columns that overlap the rows, the rows and columns having an overlap area of at least about 50%.

36. An array of interferometric modulators made by the method of claim 35.

37. A display device, comprising:
an array of interferometric modulators as claimed in claim 36;
a processor that is in electrical communication with the array, the processor being configured to process image data; and
a memory device in electrical communication with the processor.

38. The display device of claim 37, further comprising:
a driver circuit configured to send at least one signal to the array.

39. The display device of claim 38, further comprising:
a controller configured to send at least a portion of the image data to the driver circuit.

40. The display device of claim 37, further comprising:
an image source module configured to send the image data to the processor.

41. The display device of claim 40, wherein the image source module comprises at least one of a receiver, transceiver, and transmitter.

42. The display device of claim 37, further comprising:
an input device configured to receive input data and to communicate the input data to the processor.
